(19) United States
(12) Patent Application Publication
(10) Pub. No.: US 2006/0219942 A1
(43) Pub. Date: Oct. 5, 2006

(54) Radiation image conversion panel and radiation image diagnostic system

(75) Inventor: Atsunori Takasu, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/391,216

(22) Filed: Mar. 29, 2006

(30) Foreign Application Priority Data
Mar. 29, 2005 (JP) 2005-095361

(51) Int. Cl. H05B 33/00

(52) U.S. Cl. 250/484.4

(57) ABSTRACT

A phosphor layer of a radiation image conversion panel has a thickness of 100 to 300 μm and a relative density of 65 to 80%. When a radiation image taken on the conversion panel is reproduced, the size of excitation light d for reading the radiation image satisfies the expressions: d≧5r and d≦3p wherein r is the average column diameter of the columnar crystals in the phosphor layer of the radiation image conversion panel and p is the pixel size of the reproduced image. The radiation image conversion panel and a radiation image diagnostic system using such a conversion panel are suitable for an application such as mammography in which soft tissue is imaged as the principal subject with low radiation energy.

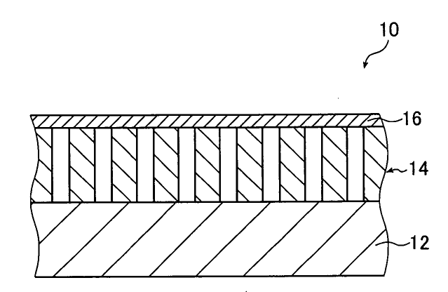

The entire contents of literatures cited in this specification are incorporated herein by reference.

### BACKGROUND OF THE INVENTION

The present invention relates to a radiation image conversion panel for recording/reproducing a radiation image by a stimulable phosphor layer made of a stimulable phosphor. More particularly, the present invention relates to a radiation image conversion panel best suited for mammography and a radiation image diagnostic system employing the radiation image conversion panel.

Upon exposure to a radiation (e.g. X-rays, α-rays, β-rays, γ-rays, electron beams, and ultraviolet rays), certain types of phosphors known in the art accumulate part of the energy of the applied radiation and, in response to subsequent application of excitation light such as visible light, they emit photostimulated luminescence in an amount that is associated with the accumulated energy. Called “storage phosphors” or “stimulable phosphors”, those types of phosphors find use in medical and various other fields.

A known example of such use is a radiation image information recording and reproducing system that employs a radiation image conversion panel having a film (or layer) of the stimulable phosphor (which is hereinafter referred to as a phosphor layer). The radiation image conversion panel is hereinafter referred to simply as the conversion panel and is also called the stimulable phosphor panel (sheet). The system has already been commercialized by, for example, Fuji Photo Film Co., Ltd. under the trade name of FCR (Fuji Computed Radiography).

In that system, a subject such as a human body is irradiated with X-rays or the like to record radiation image information about the subject on the conversion panel (more specifically, the phosphor layer). After the radiation image information is thus recorded, the conversion panel is scanned two-dimensionally with excitation light to emit photostimulated luminescence which, in turn, is read photoelectrically to yield an image signal. Then, an image reproduced on the basis of the image signal is output as the radiation image of the subject, typically to a display device such as CRT or on a recording material such as a photosensitive material.

The conversion panel is typically prepared by the following method: Powder of a stimulable phosphor is dispersed in a solvent containing a binder and other necessary ingredients to make a coating solution, which is applied to a panel-shaped support (substrate) made of glass or a resin, with the applied coating being subsequently dried.

Also known are conversion panels of the type described in JP 2002-214397 A and JP 2004-233343 A which are prepared by forming a phosphor layer on a substrate through vapor-phase film deposition (vacuum film deposition) such as vacuum deposition or sputtering. The phosphor layer formed by the vapor-phase film deposition has superior characteristics in that it is formed in vacuum and hence has low impurity levels and that being substantially free of any ingredients other than the stimulable phosphor as exemplified by a binder, the phosphor layer has not only small scatter in performance but also features very highly efficient luminescence.

The conversion panel requires that the sensitivity be high and an image (reproduced image) have excellent sharpness.

As disclosed in JP 2002-214397 A and JP 2004-233343 A, the phosphor layer formed by vapor-phase film deposition is composed of columnar crystals. In order to achieve higher sensitivity, the phosphor layer requires a certain degree of thickness and preferably has a higher relative density. On the other hand, the relative density of 100% is not preferable for the improvement in image sharpness and it is important for the phosphor layer to have voids among adjacent columns in the columnar crystals.

JP 2002-214397 A discloses that a conversion panel whose phosphor layer has a thickness of 300 to 700 μm and a relative density of 85 to 97% is produced to achieve the above object.

JP 2004-233343 A discloses that the column diameter in the phosphor layer of the conversion panel is greater on the upper side where the growth of the phosphor crystals ends than the lower side (base side) of the phosphor layer, and the ratio of the phosphor volume to the whole volume of the phosphor layer is in the range of 75 to 96% on both of the upper side and lower side.

### SUMMARY OF THE INVENTION

The conversion panels disclosed in these publications are intended for use in medical diagnoses.

However, there exists a problem that, when used in an application such as mammography in which soft tissue is a principal subject, these conversion panels are not capable of obtaining an image with sufficiently high sharpness.

The present invention has been made to solve the above-described conventional problem, and an object of the present invention is therefore to provide a radiation image conversion panel having a stimulable phosphor layer formed by vapor-phase film deposition, and particularly a radiation image conversion panel that has sufficiently high sensitivity and is capable of obtaining an image (reproduced image) with excellent graininess and extremely high sharpness in such an application as mammography.

Another object of the present invention is to provide a radiation image diagnostic system that employs the radiation image conversion panel and is suitable for mammography or other medical applications.

In order to achieve the above object, according to a first aspect of the present invention, there is provided a radiation image conversion panel, including: a substrate; and a stimulable phosphor layer formed by vapor-phase film deposition, wherein said stimulable phosphor layer has a thickness of 100 to 300 μm and a relative density of 65 to 80%.

In the radiation image conversion panel according to the first aspect of the present invention, it is preferable that said stimulable phosphor layer has a columnar crystal structure containing columnar crystals, and said columnar crystals constituting said stimulable phosphor layer has an average column diameter of 1 to 10 μm. Further, it is preferable that said stimulable phosphor layer is made of a stimulable phosphor represented by a general formula:
CsX:Eu
wherein X is at least one element selected from Cl, Br and I. Further, it is preferable that said stimulable phosphor is CsBr:Eu. Furthermore, it is preferable that said radiation image conversion panel is used to take radiation images whose subject is a soft tissue.

Futher, according to a second aspect of the present invention, there is a radiation image diagnostic system for reading a radiation image taken on a radiation image conversion panel that has a stimulable phosphor layer being formed by vapor-phase film deposition and having a thickness of 100 to 300 μm and a relative density of 65 to 80%, and for reproducing the thus read radiation image as a visible image, wherein said stimulable phosphor layer has a columnar crystal structure containing columnar crystals and a size of excitation light d for reading said radiation image satisfies expressions:
d≧5r
d≦3p,
wherein r is an average column diameter of said columnar crystals in said stimulable phosphor layer of said radiation image conversion panel and p is a pixel size of the reproduced visible image.

In the radiation image diagnostic system according to the second aspect of the present invention, it is preferable that said columnar crystals constituting said stimulable phosphor layer has an average column diameter of 1 to 10 μm. Furthre, it is preferable that said stimulable phosphor layer of said radiation image conversion panel is made of a stimulable phosphor represented by a general formula:
CsX:Eu
wherein X is at least one element selected from Cl, Br and I. Furthre, it is preferable that said stimulable phosphor used in said radiation image conversion panel is CsBr:Eu. Furthre, it is preferable that after said radiation image whose subject is a soft tissue has been taken, said radiation image is read and reproduced as said visible image. Furthremore, it is preferable that said radiation image obtained by mammography is read and reproduced as said visible image.

The present invention is capable of obtaining an image that is high in sharpness, is little affected by noise and is excellent in graininess even in applications in which the energy in radiography (radiation dose) is low and high sharpness is required, as exemplified by mammography in which soft tissue is a principal subject.

### BRIEF DESCRIPTION OF THE DRAWING

The FIGURE is a schematic cross sectional view showing an embodiment of a radiation image conversion panel of the present invention.

### DETAILED DESCRIPTION OF THE PREFERRED EMBODIMENT

The radiation image conversion panel and the radiation image diagnostic system according to the present invention will be described below in detail with reference to a preferred embodiment shown in the accompanying drawing.

The FIGURE is a conceptual view showing an embodiment of a radiation image conversion panel of the present invention.

A radiation image conversion panel (hereinafter referred to as a conversion panel) 10 in the illustrated embodiment includes a substrate 12, a stimulable phosphor layer 14 formed on the surface of the substrate 12 and a protective film 16 with which the stimulable phosphor layer 14 is covered and sealed.

This is not the sole structure of the radiation image conversion panel of the present invention and various structures are applicable as long as the stimulable phosphor layer has a predetermined thickness and a predetermined relative density as will be described later.

There is no particular limitation on the substrate 12 used in the conversion panel 10 of the present invention and various types as commonly used in conversion panels (radiation image conversion panels) are usable.

Exemplary types include plastic plates or sheets (films) made of cellulose acetate, polyester, polyethylene terephthalate, polyamide, polyimide, triacetate, polycarbonate and the like; glass plates or sheets made of quartz glass, alkali-free glass, soda glass, heat-resistant glass (e.g., Pyrex™) and the like; metal plates or sheets made of metals such as aluminum, iron, copper and chromium; plates or sheets obtained by forming a coating layer such as a metal oxide layer on the surfaces of such metal plates or sheets.

The substrate 12 may also have on the surface thereof, a protective layer, a reflective layer for reflecting photostimulated luminescence light, a protective layer for the reflective layer and the like.

The stimulable phosphor layer 14 is a layer made of a stimulable phosphor (storage phosphor). In the conversion panel 10 of the present invention, the stimulable phosphor layer (hereinafter referred to simply as the phosphor layer) 14 is formed by vapor-phase film deposition such as vacuum deposition.

The phosphor layer 14 formed by vapor-phase film deposition, and in particular the phosphor layer 14 made of an alkali halide-based stimulable phosphor to be described later as a preferred example is composed of columnar crystals. In the present invention, the phosphor layer 14 has a thickness of 100 to 300 μm and a relative density of 65 to 80%.

As described above, the radiation image conversion panel used for medical purposes requires having high sensitivity and producing an image with high sharpness.

One possibility to fulfill such requirements is that the thickness of the stimulable phosphor layer is increased to obtain sufficiently high sensitivity and the relative density of the phosphor layer is increased while ensuring voids among adjacent columns in the columnar crystals. Under the circumstances, as described above, JP 2002-214397 A discloses a radiation image conversion panel having a stimulable phosphor layer whose thickness is 300 to 700 μm and relative density is 85 to 97%.

However, according to the study made by the inventor of the present invention, an image with sufficiently high sharpness cannot be obtained when such a radiation image conversion panel is used in an application such as mammography in which soft tissue is a principal subject.

In mammography or other medical applications in which soft tissue is imaged as the principal subject, images are taken with a lower energy radiation (at a lower radiation dose) than in the case of taking radiation images like chest X-rays as commonly performed in the art. Mammography or other medical applications require that the radiation image conversion panel offer higher sharpness.

However, the amount of stimulable phosphor per unit area is preferably smaller than usual, because the application such as mammography uses lower radiation energy than common radiation images require. A stimulable phosphor used in an excessively large amount is advantageous in terms of sensitivity but produces a blurred image with low sharpness.

In the conversion panel 10 of the present invention, the phosphor layer 14 has a considerably smaller thickness and a lower relative density than usual. To be more specific, the phosphor layer 14 has a thickness of 100 to 300 μm and a relative density of 65 to 80%. The conversion panel 10 of the present invention having such a structure allows a radiation image with high sharpness to be obtained, and the thus realized conversion panel 10 is best suited for use in applications such as mammography which require lower radiation energy than in common radiation images.

When the phosphor layer 14 has a thickness of less than 100 μm, the amount of stimulable phosphor is not sufficient to ensure high sensitivity and image graininess is also impaired. When the thickness of the phosphor layer 14 exceeds 300 μm, a blurred image with low sharpness is obtained.

As described above, the phosphor layer 14 formed by vapor-phase film deposition is composed of columnar crystals and it is necessary for the phosphor layer 14 to have voids among adjacent columns in the columnar crystals (in other words, the columns must be optically independent of one another) in order to obtain an image with high sharpness. However, when the relative density of the phosphor layer 14 is less than 65%, sufficiently high sensitivity cannot be obtained, which may lead to deterioration of image graininess. When the relative density of the phosphor layer 14 exceeds 80%, optical column independence in the columnar crystals of the phosphor layer 14 cannot be fully ensured to cause deterioration of image sharpness.

In other words, the present invention having the phosphor layer 14 as described above is capable of obtaining an image with extremely high sharpness and can be also adapted for imaging with low radiation energy by the synergistic interaction among stimulable phosphor used in a necessary and sufficient amount, resolution, optical column independence ensured in the columnar crystals, and smaller thickness than usual. Therefore, the present invention can provide a conversion panel best suited for a medical diagnosis such as mammography in which soft tissue is imaged as the principal subject with low radiation energy, and in particular for mammography.

The phosphor layer 14 preferably has a thickness of 150 to 250 μm and a relative density of 65 to 75%.

When the thickness and the relative density fall within the above ranges, the conversion panel 10 obtained is higher in sensitivity and is capable of obtaining a high-quality image that is higher in sharpness, less affected by noise and more excellent in graininess.

In the present invention, there is no particular limitation on the column diameter of the columnar crystals constituting the phosphor layer 14. However, the columnar crystals constituting the phosphor layer 14 preferably have an average column diameter of 1 to 10 μm and more preferably 2 to 5 μm.

When the average column diameter of the columnar crystals constituting the phosphor layer 14 falls within the above range, more favorable results can be achieved in that the image obtained is higher in sharpness and has a smaller amount of noise.

The stimulable phosphor constituting the phosphor layer 14 of the conversion panel 10 is not particularly limited but various known stimulable phosphors can be used. Preferred examples are given below.

Stimulable phosphors disclosed in U.S. Pat. No. 3,859,527 are “SrS:Ce, Sm”, “SrS:Eu, Sm”, “ThO₂:Er”, and “La₂O₂S:Eu, Sm”.

JP 55-12142 A discloses “ZnS:Cu, Pb”, “BaO·xAl₂O₃:Eu (0.8≦x≦10)”, and stimulable phosphors represented by the general formula “M^{II}O·xSiO₂:A”. In this formula, M^{II} is at least one element selected from the group consisting of Mg, Ca, Sr, Zn, Cd, and Ba, A is at least one element selected from the group consisting of Ce, Tb, Eu, Tm, Pb, Tl, Bi, and Mn, and 0.5≦x≦2.5.

Stimulable phosphors represented by the general formula “LnOX:xA” are disclosed by JP 55-12144 A. In this formula, Ln is at least one element selected from the group consisting of La, Y, Gd, and Lu, X is at least one element selected from Cl and Br, A is at least one element selected from Ce and Tb, and 0≦x≦0.1.

Stimulable phosphors represented by the general formula “(Ba₁₋ₓ, M²⁺ₓ)FX:yA” are disclosed by JP 55-12145 A. In this formula, M²⁺ is at least one element selected from the group consisting of Mg, Ca, Sr, Zn, and Cd, X is at least one element selected from Cl, Br, and I, A is at least one element selected from Eu, Tb, Ce, Tm, Dy, Pr, Ho, Nd, Yb, and Er, 0≦x≦0.6, and 0≦y≦0.2.

JP 59-38278 A discloses stimulable phosphors represented by the general formula “xM₃(PO₄)₂·NX₂:yA” or “M₃(PO₄)₂·yA”. In this formula, M and N are each at least one element selected from the group consisting of Mg, Ca, Sr, Ba, Zn, and Cd, X is at least one element selected from F, Cl, Br, and I, A is at least one element selected from Eu, Tb, Ce, Tm, Dy, Pr, Ho, Nd, Yb, Er, Sb, Tl, Mn, and Sn, 0≦x≦6, and 0≦y≦1.

Stimulable phosphors are represented by the general formula “nReX₃·mAX′₂:xEu” or “nReX₃·mAX′₂:xEu, ySm”. In this formula, Re is at least one element selected from the group consisting of La, Gd, Y, and Lu, A is at least one element selected from Ba, Sr, and Ca, X and X′ are each at least one element selected from F, Cl, and Br, 1×10⁻⁴<x<3×10⁻¹, 1×10⁻⁴<y<1×10⁻¹, and 1×10⁻³<n/m<7×10⁻¹.

Alkali halide-based stimulable phosphors represented by the general formula “M^{I}X·aM^{II}X′₂·bM^{III}X″₃:cA” are disclosed by JP 61-72087 A. In this formula, M^{I} represents at least one element selected from the group consisting of Li, Na, K, Rb, and Cs. M^{II} represents at least one divalent metal selected from the group consisting of Be, Mg, Ca, Sr, Ba, Zn, Cd, Cu, and Ni. M^{III} represents at least one trivalent metal selected from the group consisting of Sc, Y, La, Ce, Pr, Nd, Pm, Sm, Eu, Gd, Tb, Dy, Ho, Er, Tm, Yb, Lu, Al, Ga, and In. X, X′, and X″ each represent at least one element selected from the group consisting of F, Cl, Br, and I. A represents at least one element selected from the group consisting of Eu, Tb, Ce, Tm, Dy, Pr, Ho, Nd, Yb, Er, Gd, Lu, Sm, Y, Tl, Na, Ag, Cu, Bi, and Mg, 0≦a<0.5, 0≦b<0.5, and 0≦c<0.2.

Stimulable phosphors represented by the general formula “(Ba₁₋ₓ, M^{II}ₓ)F₂·aBaX₂:yEu, zA” are disclosed by JP 56-116777 A. In this formula, M^{II} is at least one element selected from the group consisting of Be, Mg, Ca, Sr, Zn, and Cd, X is at least one element selected from Cl, Br, and I, A is at least one element selected from Zr and Sc, 0.5≦a≦1.25, 0≦x≦1, 1×10⁻⁶≦y≦2×10⁻¹ and 0<z≦1×10⁻².

Stimulable phosphors represented by the general formula “M^{III}OX:xCe” are disclosed by JP 58-69281 A. In this formula, M^{III} is at least one trivalent metal selected from the group consisting of Pr, Nd, Pm, Sm, Eu, Tb, Dy, Ho, Er, Tm, Yb, and Bi, X is at least one element selected from Cl and Br, and 0≦x≦0.1.

Stimulable phosphors represented by the general formula “Ba₁₋ₓMₐLₐFX:yEu²⁺” are disclosed by JP 58-206678 A. In this formula, M is at least one element selected from the group consisting of Li, Na, K, Rb, and Cs, L is at least one trivalent metal selected from the group consisting of Sc, Y, La, Ce, Pr, Nd, Pm, Sm, Gd, Tb, Dy, Ho, Er, Tm, Yb, Lu, Al, Ga, In, and Tl, X is at least one element selected from Cl, Br, and I, 1×10⁻²≦x≦0.5, 0≦y≦0.1, and a is x/2.

Stimulable phosphors represented by the general formula “M^{II}FX·aM^{I}X′·bM′^{II}X″₂·cM^{III}X₃·xA:yEu²⁺.” are disclosed by JP 59-75200 A. In this formula, M^{II} is at least one element selected from the group consisting of Ba, Sr, and Ca, M^{I} is at least one element selected from Li, Na, K, Rb, and Cs, M′^{II} is at least one divalent metal selected from Be and Mg, M^{III} is at least one trivalent metal selected from the group consisting of Al, Ga, In, and Tl, A is a metal oxide, X, X′, and X″ are each at least one element selected from the group consisting of F, Cl, Br, and I, 0≦a≦2, 0≦b≦1×10⁻², 0≦c≦1×10⁻², and a+b+c≧10⁻⁶, 0<x≦0.5, and 0<y≦0.2.

Alkali halide-based stimulable phosphors disclosed by JP 61-72087 A are preferred because they have excellent photostimulated luminescence characteristics and the effect of the present invention is advantageously obtained. Alkali halide-based stimulable phosphors in which M^{I} contains at least Cs, X contains at least Br, and A is Eu or Bi are more preferred, and stimulable phosphors represented by the general formula “CsX:Eu” where X is at least one element selected from Cl, Br and I are still more preferred, and stimulable phosphors represented by the general formula “CsBr:Eu” are most preferred.

In the conversion panel 10 of the present invention, such a stimulable phosphor is formed into the phosphor layer 14 by various vapor-phase film deposition (vacuum film deposition) techniques such as vacuum deposition, sputtering and CVD (chemical vapor deposition).

The deposition rate, the deposition pressure, the temperature of the phosphor layer at the time of film deposition, the distance at the time of vacuum deposition between evaporation sources and the substrate on which deposition is carried out (the distance in the vertical direction between the horizontal plane including evaporation ports through which film-forming materials are evaporated (e.g., crucible ports) and the surface of the substrate) and other factors can be adjusted as appropriate to form the phosphor layer 14 whose relative density and average column diameter fall within the ranges defined above.

Among others, vacuum deposition is preferably employed to form the phosphor layer 14 in consideration of productivity or the like.

In particular, the phosphor layer 14 is preferably formed by multi-source vacuum deposition in which a material for a phosphor component and a material for an activator component are separately evaporated under heating. For example, the phosphor layer 14 of “CsBr:Eu” is preferably formed by two-source vacuum deposition in which cesium bromide (CsBr) as a material for the phosphor component and europium bromide (EuBrₓ (x is generally 2 to 3)) as a material for the activator component are separately evaporated under heating.

There is no particular limitation on the heating method used in vacuum deposition. For example, the phosphor layer 14 may be formed through electron beam heating employing an electron gun or the like, or through resistance heating. When the phosphor layer 14 is formed through multi-source vacuum deposition, all materials may be evaporated under heating by the same heating means (such as electron beam heating). Alternatively, the film-forming materials may be evaporated under heating by means different from each other. More specifically, the material for the phosphor component may be evaporated under heating through electron beam heating, and the material for the activator component, which is in a trace amount, may be evaporated under heating through resistance heating.

There is also no particular limitation on the conditions under which the phosphor layer 14 is formed through deposition, and the conditions are determined as appropriate in accordance with the type of the vapor-phase film deposition method used, the film-forming materials used, heating means and other factors.

The phosphor layer 14 formed may be heated at 300° C. or lower, preferably at 200° C. or lower during film deposition through heating of the substrate 12 or the like. As described above, the heating temperature can be adjusted to control the relative density of the phosphor layer 14.

When any of the various stimulable phosphors described above, particularly an alkali halide-based stimulable phosphor, more particularly a stimulable phosphor represented by the general formula “CsX:Eu”, and most particularly a phosphor represented by “CsBr:Eu” is deposited in vacuo to form the phosphor layer 14 in the conversion panel 10 of the present invention, vacuum deposition is preferably carried out by evacuating once a system to a high degree of vacuum; introducing argon gas, nitrogen gas, or the like into the system to adjust the internal pressure to a degree of vacuum of about 0.01 Pa to 3 Pa (this degree of vacuum is hereinafter referred to as medium vacuum); and heating film-forming materials under medium vacuum through resistance heating.

As described above, the phosphor layer formed of the alkali halide-based phosphor such as CsBr:Eu has a columnar crystal structure, and the phosphor layer 14 obtained by film deposition under medium vacuum has a particularly favorable columnar crystal structure, and thus is preferable in terms of image sharpness and photostimulated luminescence characteristics.

As described above, the pressure during film deposition can be adjusted to control the relative density of the phosphor layer 14.

The phosphor layer 14 having been formed in this manner by vapor-phase film deposition is preferably subjected to heat treatment (annealing) so as to have excellent photostimulated luminescence characteristics.

There is no particular limitation on the conditions under which the phosphor layer 14 is heat-treated. For example, heat treatment is preferably carried out under an inert atmosphere such as a nitrogen atmosphere at 50° C. to 600° C. (preferably 100° C. to 300° C.) for 10 minutes to 10 hours (preferably 30 minutes to 3 hours). The heat treatment can be carried out in any known method such as a method employing a firing furnace. In the case where the phosphor layer 14 is formed in a vacuum deposition device having a means for heating the substrate 12, use can be made of the substrate-heating means to carry out the heat treatment.

In a preferred embodiment, the illustrated conversion panel 10 has a moisture-proof protective film 16 with which the phosphor layer 14 is covered and sealed, whereby the phosphor layer 14 is prevented from absorbing moisture.

The moisture-proof protective film (hereinafter referred to as the protective film) 16 is not limited in any particular way and various types of films as used in radiation image conversion panels each having a stimulable phosphor layer formed by vapor-phase film deposition can be used.

Examples of the protective film 16 include sheets (resin films) made of various plastics such as polyethylene terephthalate (PET), polyurethane, polyethylene naphthalate, polyethylene, polypropylene, polyvinylidene chloride and polyamide. A composite sheet obtained by laminating plural sheets may also be used.

The moisture-proof protective film 16 obtained by forming on the surface of such a sheet, a film made of an inorganic material such as silicon oxide (SiO₂), silicon nitride (Si₃N₄), aluminum oxide (Al₂O₃), aluminum nitride (AlN), zirconium oxide (ZrO₂), tin oxide (SnO₂) or magnesium oxide (MgO) is also advantageously used.

When the conversion panel 10 of the present invention as described above is manufactured, for example, the phosphor layer 14 is formed by vacuum deposition on the surface of the substrate 12. The phosphor layer 14 may be formed by a method commonly used in the art in which the layer is formed as the substrate rotates (more specifically, rotates on its axis or around some other element, or both on its axis and around some other element). However, the phosphor layer 14 is preferably formed by arranging evaporation sources such as crucibles in one direction and linearly transporting the substrate in a direction perpendicular to the direction in which the evaporation sources are arranged, more preferably linearly transporting the substrate several times in a to-and-fro manner. Use of such a forming method allows the phosphor layer 14 formed to have a more uniform thickness.

Next, an adhesive is applied as appropriate onto the surface of the prepared protective film 16, which is then superposed on the substrate 12 with the adhesive-bearing surface facing the substrate 12, so as to entirely cover the phosphor layer 14. Then, the substrate 12, or the substrate 12 and the phosphor layer 14 are adhered to the protective film 16 by thermal lamination or other technique to seal the phosphor layer 14 with the protective film 16 thereby manufacturing the conversion panel 10 as shown in the FIGURE.

Only the whole perimeter of the protective film 16 that surrounds the phosphor layer 14 may be adhered to the substrate 12. However, both the surfaces of the substrate 12 and the phosphor layer 14 may be preferably adhered to the protective film 16, because this structure prevents the protective film 16 from being separated from the phosphor layer 14 and is advantageous in strength.

Another structure is also preferably used in which a frame surrounding the phosphor layer 14 is fixed to the substrate 12 and the protective film 16 is adhered to the frame (and optionally the phosphor layer 14) to seal the phosphor layer 14 with the protective film 16. Use of such a frame prevents the phosphor layer 14 from being damaged due to impact from the exterior or the like and eliminates the height difference between the upper surfaces of the phosphor layer and the frame when the phosphor layer 14 is sealed with the protective film 16, which may lead to enhancement of the productivity and workability. In this case, the phosphor layer 14 is preferably formed after the frame has been fixed to the substrate 12.

The thus manufactured conversion panel 10 of the present invention is employed for taking and reproducing various radiation images. In particular, the conversion panel 10 of the present invention is advantageously used in an application such as mammography in which soft tissue is imaged as the principal subject with low radiation energy (at a low radiation dose), and more advantageously in mammography.

A radiation image can be taken on the conversion panel of the present invention according to a conventional method suitable for the type of the radiation image.

The thus taken radiation image is read by a method known in the art as exemplified by a method relying on so-called point scanning or line scanning.

As is well known, point scanning is a method in which a conversion panel is transported in a sub scanning direction perpendicular to a main scanning direction as beam-shaped excitation light deflected in the main scanning direction is made incident on the conversion panel, whereby the conversion panel is scanned two-dimensionally with the excitation light to emit photostimulated luminescence, which is then propagated with an optical guide to measure the quantity of light thereby reading an image. On the other hand, line scanning is a method in which linear excitation light is made incident on a conversion panel to emit photostimulated luminescence, which is then read with a line sensor as the excitation light and the line sensor on one hand, and the conversion panel on the other hand are moved relative to each other in a sub scanning direction perpendicular to the direction in which the line sensor extends, thereby reading an image.

A radiation image diagnostic system of the present invention that meets the following conditions is preferably used to read a radiation image taken on the conversion panel 10 of the present invention and to reproduce the read image.

That is, it is preferred that the size of excitation light d be not less than five times the average column diameter r and not more than three times the pixel size p.

In other words, the size of excitation light d satisfies the following expressions:
d≧5r
d≦3p
wherein r is the average column diameter in the phosphor layer 14, d is the size of excitation light (beam spot average diameter in the point scanning and average size of excitation light (average line width) in a sub scanning direction in the line scanning), p is the pixel size of a reproduced image such as an image represented on a display or reproduced on a recording medium such as a photosensitive material.

When the size of excitation light for reading is decreased, the reading resolution is increased, but the area excited at a time is narrowed, and as a result, sensitivity unevenness in each read pixel that may be caused by fluctuations in the amount of luminescence tends to be increased. In this case, the influence of noise may also tend to be increased particularly in an application such as mammography that requires low radiation energy in imaging. On the other hand, when the size of excitation light is increased, a sufficient amount of luminescence is obtained on a read-pixel unit basis, and any adverse effect of noise is eliminated to obtain an image with excellent graininess. However, the resolution is reduced and as a result a reproduced image is low in sharpness and resolution.

If the size of excitation light d is not less than five times the average column diameter r and not more than three times the pixel size p of a reproduced image, the conversion panel 10 of the present invention, when used in an application such as mammography, is capable of obtaining an image with sufficiently high definition and sharpness in a consistent manner while preventing deterioration of graininess due to uneven sensitivity or noise.

It is preferable for the size of excitation light d for reading to be not less than ten times the average column diameter r and not more than twice the pixel size p of a reproduced image, because the advantages described above can be enjoyed more appropriately.

The radiation image diagnostic system of the present invention as described above can be employed in various medical diagnoses. In particular, as well as the conversion panel of the present invention, the radiation image diagnostic system of the present invention is advantageous in an application such as mammography in which radiation images having soft tissue as the principal subject are taken with low radiation energy (at a low radiation dose), and more advantageously in mammography.

While the radiation image conversion panel and the radiation image diagnostic system according to the present invention have been described above in detail, the invention is by no means limited to the foregoing embodiment and it should be understood that various improvements and modifications can of course be made without departing from the scope and spirit of the invention.

### EXAMPLES

On the following pages, the present invention is described in greater detail with reference to specific examples. However, the present invention is not limited to these examples.

### Example 1

Europium bromide and cesium bromide were used in two-source vacuum deposition as the activator film-forming material and the phosphor film-forming material, respectively, to form the phosphor layer 14 made of CsBr:Eu on the surface of the substrate 12 thereby obtaining the conversion panel 10 having no moisture-proof protective film 16.

Both the film-forming materials were heated in a resistance heating device that used tantalum crucibles and a DC power source with an output of 6 kW.

The substrate 12 made of aluminum with an area of 450 mm×450 mm was set on a substrate holder of a vacuum deposition device and the surface of the substrate 12 was then masked so as to obtain a film-forming area with a size of 430 mm×430 mm in the center of the substrate 12. The substrate holder has substrate heating means using a sheathed heater.

Each of the film-forming materials was filled into the corresponding crucibles, which were then set at predetermined positions in the vacuum deposition device. The distance between the substrate 12 and each evaporation source (vertical distance between the horizontal plane including the crucible port and the surface of the substrate 12) was set at 15 cm for each of the film-forming materials.

Thereafter, a vacuum chamber was closed to start evacuation. A diffusion pump and a cryogenic coil were used for evacuation.

When the degree of vacuum reached 8×10⁻⁴ Pa, argon gas was introduced into the vacuum chamber to adjust the degree of vacuum to 1 Pa. Then, a DC power source was driven to energize the crucibles thereby forming the phosphor layer 14 on the surface of the substrate 12. The output of the DC power source to the crucibles filled with the film-forming materials was adjusted so that the molarity ratio of Eu/Cs in the phosphor layer 14 could be 0.001:1 and that the deposition rate could be 5 μm/min. Further, the substrate 12 was heated to 100° C. by the sheathed heater of the substrate holder. The deposition rate was controlled based on a previously conducted experiment.

At the time the thickness of the phosphor layer 14 had reached about 110 μm, film deposition was finished and the substrate 12 was taken out of the vacuum chamber.

Then, the substrate 12 on which film deposition had been made was heat-treated under a nitrogen atmosphere at a temperature of 200° C. for two hours to obtain the conversion panel 10 having no moisture-proof protective film 16.

The relative density of the phosphor layer 14 formed was calculated from the weight, area and thickness of the phosphor deposited onto the substrate 12. As a result, the relative density of the phosphor layer 14 was 67%.

A scanning electron microscope (SEM) was used to take electron micrographs at three points on the surface of the phosphor layer 14 formed. Then, the column diameters of columnar crystals included in a 0.5 mm square region were measured and their average was calculated. As a result, the phosphor layer 14 had an average column diameter of 1.3 μm.

The thickness of the phosphor layer, the distance between the substrate 12 and each evaporation source, the substrate-heating temperature, the deposition pressure, and the deposition rate are shown in Table 1.

The thickness, the relative density and the average column diameter of the phosphor layer are shown in Table 2.

### Example 2

The conversion panel 10 was prepared by repeating Example 1 except that the thickness of the phosphor layer 14 was changed to 170 μm. The relative density and the average column diameter were measured in the same manner. As a result, the phosphor layer 14 had a relative density of 75% and an average column diameter of 2.1 μm.

As in Example 1, the thickness of the phosphor layer, the distance between the substrate 12 and each evaporation source, the substrate-heating temperature, the deposition pressure, and the deposition rate are shown in Table 1, and the thickness, the relative density and the average column diameter of the phosphor layer in Table 2.

### Example 3

The conversion panel 10 was prepared by repeating Example 1 except that the distance between the substrate 12 and each evaporation source was changed to 12 cm, the substrate-heating temperature during film deposition to 50° C., the deposition pressure to 1.2 Pa and the deposition rate to 10 μm/min. The relative density and the average column diameter were measured in the same manner. As a result, the phosphor layer 14 had a relative density of 78% and an average column diameter of 3.4 μm.

As in Example 1, the thickness of the phosphor layer, the distance between the substrate 12 and each evaporation source, the substrate-heating temperature, the deposition pressure, and the deposition rate are shown in Table 1, and the thickness, the relative density and the average column diameter of the phosphor layer in Table 2.

### Comparative Example 1

The conversion panel 10 was prepared by repeating Example 1 except that the substrate-heating temperature during film deposition was changed to 50° C. and the thickness of the phosphor layer to 90 μm. The relative density and the average column diameter were measured in the same manner. As a result, the phosphor layer 14 had a relative density of 64% and an average column diameter of 0.9 μm.

As in Example 1, the thickness of the phosphor layer, the distance between the substrate 12 and each evaporation source, the substrate-heating temperature, the deposition pressure, and the deposition rate are shown in Table 1, and the thickness, the relative density and the average column diameter of the phosphor layer in Table 2.

### Comparative Example 2

The conversion panel 10 was prepared by repeating Example 1 except that the distance between the substrate 12 and each evaporation source was changed to 12 cm, the substrate-heating temperature during film deposition to 50° C., the deposition pressure to 1.2 Pa, the deposition rate to 10 μm/min and the thickness of the phosphor layer to 400 μm. The relative density and the average column diameter were measured in the same manner. As a result, the phosphor layer 14 had a relative density of 88% and an average column diameter of 5.2 μm.

As in Example 1, the thickness of the phosphor layer, the distance between the substrate 12 and each evaporation source, the substrate-heating temperature, the deposition pressure, and the deposition rate are shown in Table 1, and the thickness, the relative density and the average column diameter of the phosphor layer in Table 2.

Image sharpness and graininess were measured for each of the thus obtained conversion panels.

A radiation image taken on each conversion panel was read by point scanning in which the average beam size was 100 μm. The pixel size of a reproduced image was 50 μm.

[Sharpness]

An MTF measuring chart was placed on the surface of each of the prepared conversion panels and the whole surface was irradiated with 28 kVp (corresponding to 20 mR) X-rays from a Mo target. Thereafter, reading was carried out with a radiation image reader (beam spot average diameter of excitation light: 100 μm; pixel size: 50 μm) and MTF (2 cycles/mm) was calculated from the resultant image data.

The sharpness of each conversion panel in terms of MTF was evaluated relative to that of the conversion panel in Example 2 having been rated as 100.

[Graininess]

The whole surface of each of the prepared conversion panels was irradiated with 28 kVp (corresponding to 20 mR) X-rays from a Mo target. Then, reading was carried out with the radiation image reader (beam spot average diameter of excitation light: 100 μm; pixel size: 50 μm) and the graininess (RMS) was measured from the resultant image data.

The graininess of each conversion panel in terms of RMS was evaluated relative to that of the conversion panel in Example 3 having been rated as 100.

The results are also shown in Table 2.

The sharpness (MTF) of not less than 80 and the graininess (RMS) of not more than 150 were criteria for evaluation. A conversion panel that satisfied both the criteria was rated as “Good” and a conversion panel that did not satisfy at least one of the criteria was rated as “Poor”. The results are also shown in Table 2.

TABLE 1

| | | Distance | | | |
|---|---|---|---|---|---|
| | | between | | | |
| | | substrate | Substrate- | | |
| | Thickness of | and each | heating | | |
| | phosphor layer | evaporation | temperature | deposition | Deposition rate |
| | (μm) | source (cm) | (° C.) | pressure (Pa) | ((μm/min) |
| Example 1 | 110 | 15 | 100 | 1 | 5 |
| Example 2 | 170 | 15 | 100 | 1 | 5 |
| Example 3 | 280 | 12 | 50 | 1.2 | 10 |
| Comparative | 90 | 15 | 50 | 1 | 5 |
| Example 1 | | | | | |
| Comparative | 400 | 12 | 50 | 1.2 | 10 |
| Example 2 | | | | | |

TABLE 2

| | | | | Sharpness | Graininess | |
|---|---|---|---|---|---|---|
| | Thickness of | | Average | (MTF 2 c/mm) | (RMS) | |
| | phosphor | Relative | column | relative | relative | |
| | layer (μm) | density (%) | diameter (μm) | value | value | Evaluation |
| Example 1 | 110 | 67 | 1.3 | 109 | 140 | Good |
| Example 2 | 170 | 75 | 2.1 | 100 | 120 | Good |
| Example 3 | 280 | 78 | 3.4 | 83 | 100 | Good |
| Comparative | 90 | 64 | 0.9 | 112 | 160 | Poor |
| Example 1 | | | | | | |
| Comparative | 400 | 88 | 5.2 | 67 | 80 | Poor |
| Example 2 | | | | | | |

As shown in these Tables, Examples 1 to 3 in which the thickness and relative density of each of the phosphor layers 14 fall within the scope of the invention achieve excellent results on both the sharpness and graininess. On the other hand, Comparative Example 1 in which the relative density is lower than that of each of the conversion panels of the present invention is excellent in sharpness but is poor in graininess, and Comparative Example 2 in which the phosphor layer is thicker than that of the conversion panels of the present invention is excellent in graininess but is poor in sharpness. The latter two conversion panels are not suitable for use in mammography.

The above results clearly show the effects of the present invention.

What is claimed is:

1. A radiation image conversion panel comprising:
a substrate; and
a stimulable phosphor layer formed by vapor-phase film deposition,
wherein said stimulable phosphor layer has a thickness of 100 to 300 μm and a relative density of 65 to 80%.

2. The radiation image conversion panel according to claim 1, wherein said stimulable phosphor layer has a columnar crystal structure containing columnar crystals, and said columnar crystals constituting said stimulable phosphor layer has an average column diameter of 1 to 10 μm.

3. The radiation image conversion panel according to claim 1, wherein said stimulable phosphor layer is made of a stimulable phosphor represented by a general formula:
CsX:Eu
wherein X is at least one element selected from Cl, Br and I.

4. The radiation image conversion panel according to claim 3, wherein said stimulable phosphor is CsBr:Eu.

5. The radiation image conversion panel according to claim 1, wherein said radiation image conversion panel is used to take radiation images whose subject is a soft tissue.

6. The radiation image conversion panel according to claim 5, wherein said radiation image conversion panel is used for mammography.

7. A radiation image diagnostic system for reading a radiation image taken on a radiation image conversion panel that has a stimulable phosphor layer being formed by vapor-phase film deposition and having a thickness of 100 to 300 μm and a relative density of 65 to 80%, and for reproducing the thus read radiation image as a visible image,
wherein said stimulable phosphor layer has a columnar crystal structure containing columnar crystals and a size of excitation light d for reading said radiation image satisfies expressions:
d≧5r
d≦3p,
wherein r is an average column diameter of said columnar crystals in said stimulable phosphor layer of said radiation image conversion panel and p is a pixel size of the reproduced visible image.

8. The radiation image diagnostic system according to claim 7, wherein said columnar crystals constituting said stimulable phosphor layer has an average column diameter of 1 to 10 μm.

9. The radiation image diagnostic system according to claim 7, wherein said stimulable phosphor layer of said radiation image conversion panel is made of a stimulable phosphor represented by a general formula:
CsX:Eu
wherein X is at least one element selected from Cl, Br and I.

10. The radiation image diagnostic system according to claim 9, wherein said stimulable phosphor used in said radiation image conversion panel is CsBr:Eu.

11. The radiation image diagnostic system according to claim 7, wherein after said radiation image whose subject is a soft tissue has been taken, said radiation image is read and reproduced as said visible image.

12. The radiation image diagnostic system according to claim 11, wherein said radiation image obtained by mammography is read and reproduced as said visible image.
